(19) United States
(12) Patent Application Publication
(10) Pub. No.: US 2003/0032518 A1
(43) Pub. Date: Feb. 13, 2003

(54) Gear reduction unit, and sub-assembly for unit

(76) Inventors: Hendrikus Jan Kapaan, Nieuwegein (NL); Jacobus Zwarts, Nieuwegein (NL)

Correspondence Address: Oliff & Berridge, PO Box 19928, Alexandria, VA, 22320, US

(21) Appl. No.: 10/181,377

(22) PCT Filed: Jan. 26, 2001
(86) PCT No.: PCT/NL01/00052

(30) Foreign Application Priority Data
Jan. 26, 2000 (NL) 1014177

(51) Int. Cl. F16H 1/32

(52) U.S. Cl. 475/162

(57) ABSTRACT

A subassembly for an eccentric gear reduction unit comprises a mounting sleeve (1) and two coaxial shafts (2, 3). one of said shafts being rotatably supported with respect to the mounting sleeve by means of a support rolling element bearing (4), the other of said shafts being rotatably supported with respect to the support rolling element bearing and/or the one shaft (2) by means of an eccentric rolling element bearing, said eccentric rolling element bearing also supporting an eccentric gear wheel (6) to which the other shaft (3) is connected, which eccentric gear wheel is intended for engagement with a fixed ring gear (7) which is coaxial with respect to both shafts.

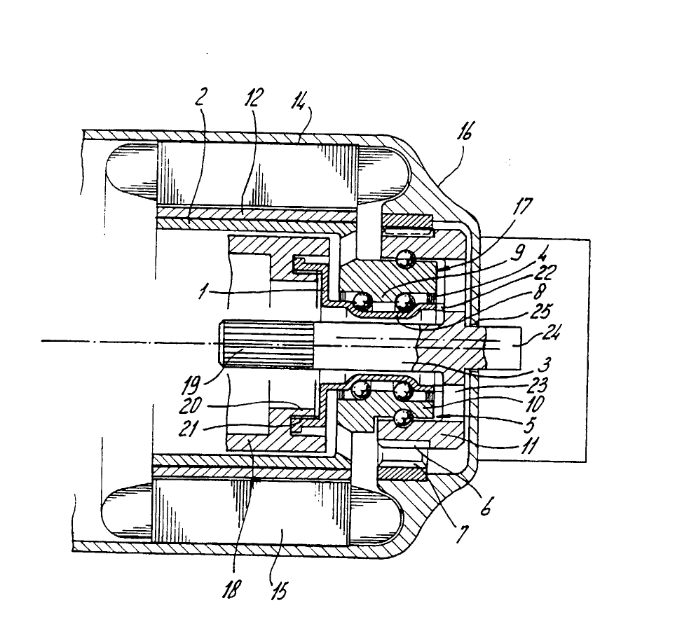

The invention is first of all related to a sub-assembly for an eccentric gear reduction unit. The eccentric gear reduction unit in question can be applied for several purposes, e.g. for providing a compact device which reduces the number of revolutions of an electric motor for driving for instance a screw actuator in a disc brake. Other applications for eccentric gear reductions are known as well, such as for clutches, continuously variable transmissions etc.

The object of the invention is to provide a sub-assembly, which can be assembled beforehand, and which can be installed as a unity in the envisaged application. To that end, the sub-assembly comprises a mounting sleeve and two coaxial shafts, one of said shafts being rotatably supported with respect to the mounting sleeve by means of a support rolling element bearing, the other of said shafts being rotatably supported with respect to the support rolling element bearing and/or the one shaft by means of an eccentric rolling element bearing, said eccentric rolling element bearing also supporting an eccentric gear wheel to which the other shaft is connected, which eccentric gear wheel is intended for engagement with a fixed ring gear which is coaxial with respect to both shafts.

Each of the two shafts in question can be a drive shaft, or a driven shaft.

A compact embodiment is obtained in case the mounting sleeve is integrated with the inner ring of the support rolling element bearing. Said mounting sleeve and integrated inner ring preferable consist of a sheet metal.

In order to obtain the desired eccentricity in the eccentric gear reduction, the outer ring of the support rolling element bearing is integrated with an eccentric inner ring of the eccentric rolling element bearing. Furthermore, the outer ring of the eccentric rolling element bearing is integrated with the eccentric gear wheel.

In the alternative, the outer ring of the support element bearing is connected to an inner ring of the eccentric rolling element bearing, said inner ring having a hole which is eccentric with respect to its raceway.

In case the sub-assembly is applied for use in conjunction with an electric motor. the outer ring of the support rolling element bearing is integrated with a tubular shaft. Said tubular shaft in that case carries permanent magnets so as to form the rotor of an electric motor, the stator of which is connected to a housing which also carries the fixed ring gear.

A very compact embodiment is obtained in case the other shaft extends at least partly through the mounting sleeve and the tubular shaft.

The invention is also related to an eccentric gear reduction unit, comprising a housing, a sub-assembly as described before, said sub-assembly comprising a mounting sleeve and two coaxial shafts, one of said shafts being rotatably supported with respect to the mounting sleeve by means of a support rolling element bearing, the other of said shafts being rotatably supported with respect to the support rolling element bearing and/or the one shaft by means of an eccentric rolling element bearing, said eccentric rolling element bearing also supporting an eccentric gear wheel to which the other shaft is connected, which eccentric gear wheel engages a fixed ring gear which is coaxial with respect to both shafts, the mounting sleeve and the ring gear being connected to the housing.

The housing may carry the stator of an electric motor, one of the shafts being of tubular shape and carrying permanent magnets so as to constitute the rotor of said electric motor. Said electromotor may be carried out with or without brushes.

The invention will be explained further with reference to an embodiment of the eccentric gear reduction unit comprising the sub-assembly according to the invention. as shown in the drawing.

The eccentric gear reduction unit shown in the FIGURE comprises a housing 16. part of which has been shown. This housing 16 may be connected to a device to be driven by the motor 14 accommodated within the housing, such as a screw actuator. The housing 16 furthermore comprises a sub-assembly 17, which has a mounting sleeve 1 mounted onto a constructional part 18 which is connected to the housing 16.

Said mounting sleeve 1 is of sheet metal, and is integrated with the inner ring 8 of the support rolling element bearing 4. The outer ring, 9 of the support rolling element bearing 4 is integrated with the eccentric inner ring 10 of the eccentric rolling element bearing 5.

The outer ring 11 of the eccentric rolling element bearing 5 is integrated with the eccentric gear wheel 6. Said eccentric outer ring 11 of the eccentric rolling element bearing 5 is connected to the inner shaft 3, which by means of the groove/spline connection 19 can be connected to the device to be driven, e.g. a screw actuator (not shown).

The integrated outer ring 9 of the bearing 4 and the integrated inner ring 10 of the bearing 5 form a unity with the outer tubular shaft 2, on the outer circumference of which permanent magnets 12 are mounted.

The permanent magnets 12 are in close vicinity of the stator 15 of the motor 14.

The housing 16 furthermore carries a ring gear 7, which is concentric with respect to the shafts 2, 3. The ring gear 7 and the eccentric gear 6 are in engagement with each other over only a part of their teeth, thus providing an eccentric gear reduction. The advantage of the sub-assembly 17 according to the invention is that it can be assembled beforehand, and that it can be connected to the constructional part 18 of the housing 16 as a unity, for instance by means of the screw thread 21 accommodated on the bushing 20 of the constructional part 18, and on the mounting sleeve 1. The mounting sleeve 1 has axial teeth 22, which can be driven by a suitable tool through the openings 23 in the integrated shaft 3/outer ring 11 for fixing the mounting sleeve 1 by screwing. Said openings 23 also provide a weight reduction.

Subsequently, the housing 16 with the stator 15 can be applied, whereby the gear wheels 6, 7 engage each other.

The shaft 3 has an extension piece 24 extending through the hole 25 of the housing 16. Said extension piece 24 may be used for an auxiliary drive, e.g. for a handbrake drive in case the unit is applied in a disc brake.

1. Sub-assembly for an eccentric gear reduction unit, said sub-assembly comprising a mounting sleeve (1) and two coaxial shafts (2, 3), one of said shafts being rotatably supported with respect to the mounting sleeve (1) by means of a support rolling element bearing (4), the other of said shafts being rotatably supported with respect to the support rolling element bearing (4) and/or the one shaft (2) by means of an eccentric rolling element bearing (5), said eccentric rolling element bearing (5) also supporting an eccentric gear wheel (6) to which the other shaft (3) is connected which eccentric gear wheel (6) is intended for engagement with a fixed ring gear (7) which is coaxial with respect to both shafts (2, 3).

2. Sub-assembly according to claim 1, wherein the mounting sleeve (1) is integrated with the inner ring (8) of the support rolling element bearing (4).

3. Sub-assembly according to claim 2, wherein the mounting sleeve (1) and integrated inner ring (8) consist of a sheet metal.

4. Sub-assembly according to claim 1, 2 or 3, wherein the outer ring (9) of the support rolling element bearing (4) is integrated with an eccentric inner ring (10) of the eccentric rolling element bearing (5).

5. Sub-assembly according to claim 4, wherein the outer ring (11) of the eccentric rolling element bearing (5) is integrated with the eccentric gear wheel (6).

6. Sub-assembly according to claim 1, 2 or 3, wherein the outer ring of the support rolling element bearing (4) is connected to an inner ring of the eccentric rolling element bearing (5), said inner ring having a hole which is eccentric with respect to its raceway.

7. Sub-assembly according to claim 4, 5 or 6, wherein the outer ring (9) of the support element bearing (4) is integrated with a tubular shaft (2).

8. Sub-assembly according to claim 7, wherein the tubular shaft (2) surrounds the mounting sleeve (1).

9. Sub-assembly according to claim 7 or 8, wherein the tubular shaft (2) carries permanent magnets (12) so as to form the rotor (13) of an electric motor (14), the stator (15) of which is connected to a housing (16) which also carries the fixed ring gear (7).

10. Sub-assembly according to claim 7, 8 or 9, wherein the other shaft (3) extends at least partly through the mounting sleeve (1).

11. Sub-assembly according to claim 7, 8, 9 or 10, wherein the other shaft (3) at least partly extends through the tubular shaft (2).

12. Sub-assembly according to any of the preceding claims, wherein at least one of the components is obtained by means of powder metallurgy.

13. Eccentric gear reduction unit, comprising a housing (16), a sub-assembly according to one of the preceding claims, said sub-assembly comprising a mounting sleeve (1) and two coaxial shafts (2, 3), one of said shafts being rotatably supported with respect to the mounting sleeve (1) by means of a support rolling element bearing (4), the other of said shafts being rotatable supported with respect to the support rolling element bearing (4) and/or the one shaft (2) by means of an eccentric rolling element bearing (5), said eccentric rolling element bearing (5) also supporting an eccentric gear wheel (6) to which the other shaft (3) is connected, which eccentric gear wheel (6) engages a fixed ring gear (7) which is coaxial with respect to both shafts (2, 3), the mounting sleeve (1) and the ring gear (7) being connected to the housing (16).

14. Unit according to claim 12, wherein the housing (16) carries the stator (15) of an electric motor (14), one (2) of the shafts being of tubular shape and carrying permanent magnets (12) so as to constitute the rotor (13) of said electric motor (14).
